(19) United States
(12) Patent Application Publication
(10) Pub. No.: US 2013/0187389 A1
(43) Pub. Date: Jul. 25, 2013

(54) METHOD FOR PREDICTIVE MONITORING OF SWITCH CONTACTORS AND SYSTEM THEREFOR

(71) Applicants: Arunvel Thangamani, Chennai (IN); Boopathi Nagarajan, Chennai (IN)

(72) Inventors: Arunvel Thangamani, Chennai (IN); Boopathi Nagarajan, Chennai (IN)

(73) Assignee: GAMESA INNOVATION & TECHNOLOGY, S.L.

(21) Appl. No.: 13/355,979

(22) Filed: Jan. 23, 2012

(51) Int. Cl. F03D 9/00; G06F 19/00

(52) U.S. Cl. 290/55; 702/65

(57) ABSTRACT

Method and system for predictive maintenance of switch contactors, preferably of converters in wind turbine generators, comprising measuring the temperature of an element located outside a switch contactor enclosure in contact with the contactors inside the enclosure, and calculating said switch contactor temperature based on said element temperature and predetermined correction values, and measuring the current through the switch contactor, and calculating a switch contact resistance value based on said calculated switch contact temperature and said measured current through the contactor, and determining a maintenance parameter of said switch contact by comparing said calculated switch contact resistance value to a predetermined nominal contact resistance value.

### FIELD OF THE INVENTION

The present invention refers to a method and system for predictive maintenance of switch contactors and a system therefor, especially for doubly fed induction generators in wind turbines.

### BACKGROUND OF THE INVENTION

The demand for high reliability in wind turbine systems requires long term service with fault-free operation and low downtime. It is known that switch contactors are a key component in generator systems for wind turbines. Particularly in doubly fed generator systems they are used to energize and de-energize a rotor circuit through small power converters. A number or wear factors shorten the lifetime of said contacts. Typically these factors include the number of start-stops, the breaking current, the number of operating hours, overloads, inrush current and temperature. Other factors that greatly affect the lifespan of contactor are short circuits and over current occurring during operation.

It is well known that manufacturers provide data sheets with estimated lifetime for contactors. Tests are usually performed under controlled conditions in laboratories. The document US2008018355 A1 discloses a test and reliability evaluation apparatus that has a hermetic and heat insulating structure where wafer contacts are tested. A simulated environment controlling heat and temperature offers evaluation of wafer contactors under accelerated conditions. However, these lab tests are not aro not very accurate for the field parameters, as the practical loading cycle on the contactor may exceed its specifications and the working conditions of the contact vary during real operation. The limitations of using estimated values based on data sheets from the manufacturers is that they only reflect information from available test data at the time of component testing or certification. Hence, the given data is only for the conditions under which the tests are performed. So, the lifespan predictions given in the data sheet may greatly differ because the wind turbine converter field environment results to be quite different from most of the laboratory tests set up.

Maintenance protocols largely consist of routine visual inspections by specialized servicing personnel. These inspections only detect some impending faulty conditions and are very inaccurate. Moreover there are limitations in a manual or visual inspection, typically the inspection frequency, the quality of measurements, the inspection arrangements and time needed, maintaining the history and properly logging data, analyzing the results, the accuracy of the decisions and others.

An object of the present invention is to provide a method and a system that provide accurate estimations of maintenance parameters of switch contactors, especially of their estimated lifetime or lifespan.

Another object of the present invention is to provide maintenance information on-line or continuously and so monitor the switch electrical contacts in real time.

Yet another object of the present invention is to provide contact maintenance information without directly accessing the high power, high voltage or high current that are present inside the contactor enclosure.

Yet another object of the present invention is to monitor electrical contacts and provide maintenance information without the need to stop or interrupt operation.

Another object of the present invention is to avoid unexpected downtimes of the wind turbine generator and to increase safety operation.

### SUMMARY OF THE INVENTION

The present invention refers to a method and a system for predictive maintenance of switch contactors. The method comprises: measuring the temperature of an element located outside a switch contactor enclosure, said element being in contact with at least one switch contactor inside said switch contactor enclosure, and calculating said switch contactor temperature based on said element temperature and predetermined correction values, and measuring the current through the switch contactor, and calculating a switch contact resistance value based on said calculated switch contact temperature and said measured current through the contactor, and determining a maintenance parameter of said switch contact by comparing said calculated switch contact resistance value to a predetermined nominal contact resistance value.

The switch contact enclosure is normally defined by the isolating casing that contains the components at high power or high current.

The element outside the switch contact enclosure is preferably a lug located on the outside surface of the switch contactor enclosure.

The method advantageously updates the maintenance parameter in real time and sends the updated output maintenance parameter to a monitoring unit of a wind turbine generator in real time.

The maintenance parameter is preferably the estimated lifetime or the failure rate of said switch contactors.

The calculation of the failure rate is based on a nominal failure rate multiplied by one or more factors selected from a group consisting of a load stress factor, a switch contact form factor, a cycling factor, an application and construction factor, a quality factor and an environmental factor.

The load stress factor is based on the quotient between the operating load current and the rated resistive load current. The switch contact form factor preferably has a value between 2 and 3.

The switch contact cycling factor is approximately 10 when the number of cycles per hour of the switch contact is more than one cycle per hour, and the cycling factor is approximately 0.1 when the number of cycles per hour of the switch contactor is less than on cycle per hour.

The application and construction factor is approximately 12 and the quality factor ranging between 0.1 and 1.5 while the environmental factor for wind turbines ranges between 0.1 and 1.5.

Measuring the first temperature of the lug includes mounting at least one thermocouple temperature sensor on said lug. On the other hand, calculating said switch contact resistance is preferably based on the following equation:

I²R=kT

where I is the current flow though the contactor, R the resistance of the switch contact, T the temperature thereof and k is a constant, wherein the constant k is suppressed from the calculation by measuring at least a test current Itest, a test contact resistance Rtest and a test contact temperature Ttest.

The present invention also defines a system for predictive maintenance of switch contactors comprising:

a temperature sensor for measuring the temperature of an element located outside a switch contactor enclosure, said element being in contact with at least one switch contactor inside said switch contactor enclosure,
a first calculating unit for calculating said switch contactor temperature based on said element temperature and a predetermined correction value,
a current sensor for measuring the current through the switch contactor,
a second calculating unit for calculating a switch contact resistance value based on said calculated switch contact temperature and said measured current through the contactor,
a third calculating unit for determining a maintenance parameter of said switch contact by comparing said calculated switch contact resistance value to a predetermined nominal contact resistance value.

The current sensor is advantageously a current transformer while the temperature sensor is a thermocouple mounted on a lug on said switch contact enclosure. Both of them may be connected to a programmable logic computer with an output for sending updated maintenance parameters to a monitoring system of a wind turbine generator.

A wind turbine generator according to the present invention preferably comprises a system for predictive maintenance of switch contactors as defined above wherein the predictive maintenance system is located in the vicinity of the switch contactors that inject current into a rotor circuit of said wind turbine generator. The wind turbine generator may typically be a doubly fed induction generator.

### FIGURES

FIG. 1 shows an embodiment of the present invention depicting the cross section of a switch contact.

FIG. 2 shows a schematic view of a wind turbine electrical equipment having a monitoring switch contact monitoring system.

FIG. 3 shows a preferred hardware arquitecture with temperature sensors on the lugs of the switch contactor enclosure and a current transformer.

FIG. 4 shows a bock diagram structure with a database of stored standards, and data sheets from manufacturers.

### DESCRIPTION OF THE PREFERRED EMBODIMENTS

The maintenance parameters are based on switch contact calculations and estimations. The more a contact increases its resistance value, the more it shows wear and tear and the more it approaches the end of its useful lifetime.

Contact resistance is computed from the contact temperature and the current flow through the contact. A preferred mathematical formula is described as:

I²R=kT

wherein I is the current flow though the contactor, R the resistance of the switch contact, T the temperature thereof and k is a constant.

In fact the switch contact resistance can be computed because the multiplication of resistance with the square of current is proportional to the temperature. However, measuring the switch contact temperature inside high power electrical equipment, typically closed cabinets and enclosures, is not practical. Access to the contacts is difficult and may result in dangerous exposure to electrical hazards. Thus, the present invention makes an indirect measurement of said switch contact temperature. A temperature measurement is made of a point outside the switching enclosure, but yet said point being in contact with the switch contact itself. An inference or correlation method, or any other method based on experimental or theoretical data is used to obtain a correlation between said two given temperatures.

Lugs are present on the outside part of high power enclosures. A temperature sensor is preferably situated on said lugs, typically a thermocouple. Through a correction factor, either by using empirical techniques, by correlation, inference or other techniques the temperature of the contact itself is calculated.

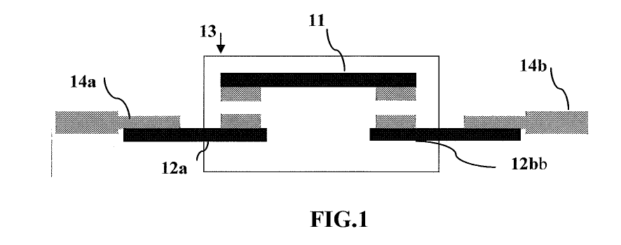

FIG. 1 shows the cross section of a normal contactor arrangement. The figure shows a moving contact unit 11 and a fixed contact unit 12 having a first contact 12a and a second contact 12b. These contacts are isolated from the environment by a housing or enclosure 13 and cannot be readily accessed from outside. The contact to the exterior of the enclosure is preferably made through lugs. A first external conductor 14a is attached or fixed to a first lug. Said first contact 14b is also attached to the lug.

A lug is to be understood as a fastener, typically a bolt, on an enclosure tied to an electric potential within the enclosure, supporting the connection of a conductor of a cable.

In operation, the closing and opening of the contact units allows high current and power to be fed to the electrical circuit, typically a wind turbine generator rotor system.

Another embodiment of the present invention for calculating the contact resistance uses a predetermined correction value generally obtained during tests in the laboratory. One or more test measurements are taken, namely contact temperature during test Ttest, current flow during test Itest and contact resistance during test, Rtest. However, the use of theoretical models may also be envisaged.

Calculating the real contact resistance, i.e. the contact resistances in the field operation, the following equations are observed:

(Ireal²/Itest²)×(Rreal/Rtest)=(Treal/Ttest)

Rreal=(Treal/Ttest)×(Itest²/Ireal²)×Rtest

Thus, test measurements are preferably used to obtain the real switch contact resistance Rreal. Other methods to obtain switch contact resistance may be based on y inference, extrapolation, correlation or other estimation methods.

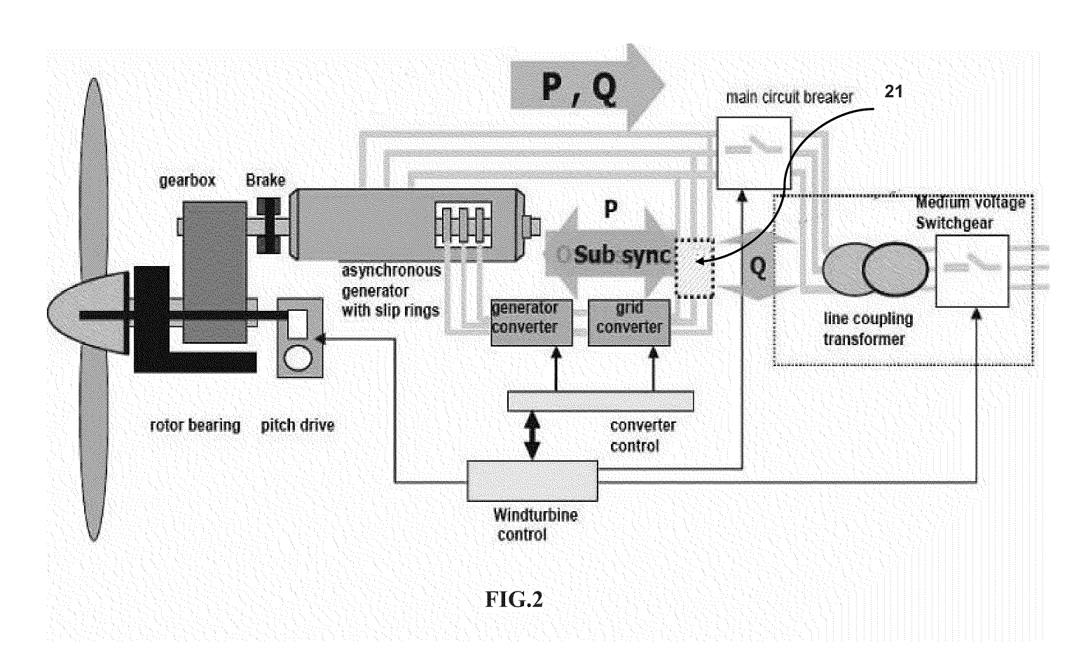

FIG. 2 shows the electrical arrangement of a wind turbine generator. The mechanical rotation of a turbine is taken to an asynchronous generator, preferably through a gearbox. Said generator preferably comprises a rotor with slip rings that are connected to a generator converter and a grid converter. To start operation and attain synchronous speed current is injected to the rotor through a controlled converter, typically comprising said grid converter and generator converter. A converter control unit operates the switch contactors in the converters. The present invention monitors the state of said switch contactors advantageously in real time. Unit 21 in figure shows a preferred location for the monitoring unit. Unit 21 monitors the converters, namely the switch contact resistance of the contactors inside the converters.

Real time or on-line must be understood as synonyms in monitoring the health of the switch contactors. The present invention monitors the performance of said contacts frequently at preferably at regular intervals. Monitoring is an aid for maintenance purposes.

In the preferred case of double fed generators, the converters are used only on the rotor circuit and the stator is connected directly to the grid. In this circuit, the electrical power is delivered both through the rotor and the stator if the generator is running super-synchronously. On the other hand electrical power is only delivered from the stator to grid and the power is injected into the rotor from the grid if the generator is running sub-synchronously. Furthermore, the arrangement of FIG. 2 allows the control of both active P and reactive power Q thus giving a better grid performance.

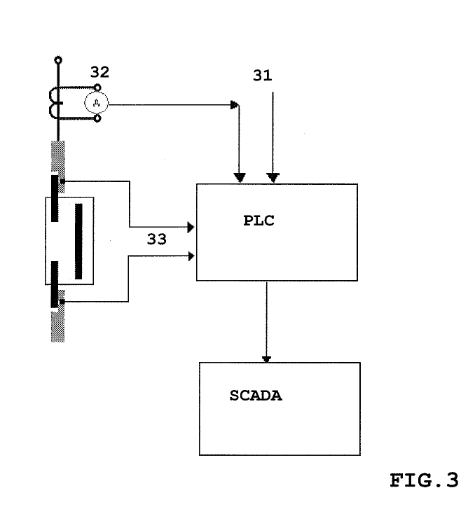

FIG. 3 shows embodiment of a preferred system for predictive maintenance of switch contactors including its instrumentation configuration. The current flow through the contact is measured using a current transformer 32. The measured current signal is given to a programmable logic circuit PLC as an analog input. The current transformer is of a suitable ration based on the current flow, preferably between 1000/5 and 1000/1. A signal conditioner converts said current signal into an analog voltage or current suitable for PLC input.

Additionally the elements outside the switch contactor enclosure are mounted with thermocouples. Advantageously the thermocouples are located on the lugs of the contactors. The temperature data from said thermocouples is also given to the PLC where the computing is made.

As mentioned before the contact switch temperature, namely that at the contact pole is computed from empirical and experimental data. This data is given in standards, e.g. military standards, as well as in the data sheet given from the contactor manufacturers. Inductive analytical methods may also be used, for instance including failure mode, effects and critically analysis FMECA. PLC signals prompt the maintenance personnel, preferably through SCADA, for repair if the computed values are about to cross alarm thresholds or limits. In effect, the maintenance personnel can change the contactors well before any breakdown occurs. Moreover, the complete history of real time data is kept in the SCADA system for later retrieval and analysis.

Maintenance parameters according to the present invention include warning and alarm signals, as well as predictive estimations of the lifetime or lifespan of switch contactors. Real time and online estimation of failure rates and reliability figures are within the scope of the present invention.

The failure rate of a contactor assembly is preferably estimated with the following equation:

λₚ=λ_{b}π_{L}π_{C}π_{CYC}π_{F}π_{Q}π_{E}failures/10⁶ hours

wherein λₚ is the failure base rate derived from standards, typically military standards, λₚ is the base failure rate taken from the standard datasheet. The other multiplying factors are given as follows:

π_{L} is the load stress factor. Since the contactor is being used in between the converter and grid, the power factor is close to Unity. The load is then considered as resistive. The load stress factor is then given as:

π_{L}=exp(s/0.8)²

where S is the ratio between the operating load current and the rated resistive load current.
π_{C} is the contact form factor, which ranges preferably between 2 and 3.
π_{CYC} is a cycling factor. Said factor is 10 if the cycle rate is more than one cycles per hour and is given as 0.1 if the cycle rate is less than one cycle per hour.
π_{F} is the application and construction factor, normally 12 for a military application.
π_{Q} is the quality factor for a contactor and may range between 0.1 and 1.5.
π_{E} is the environmental factor, being approximately 15 for a wind turbine.

Once the failure rate is known, reliability can be calculated either based on Weilbull analysis of exponential distribution as shown in the following equation:

R(t)=e^{-λ}^{ₚ}^{time}

wherein λₚ is the failure base rate derived from standards.

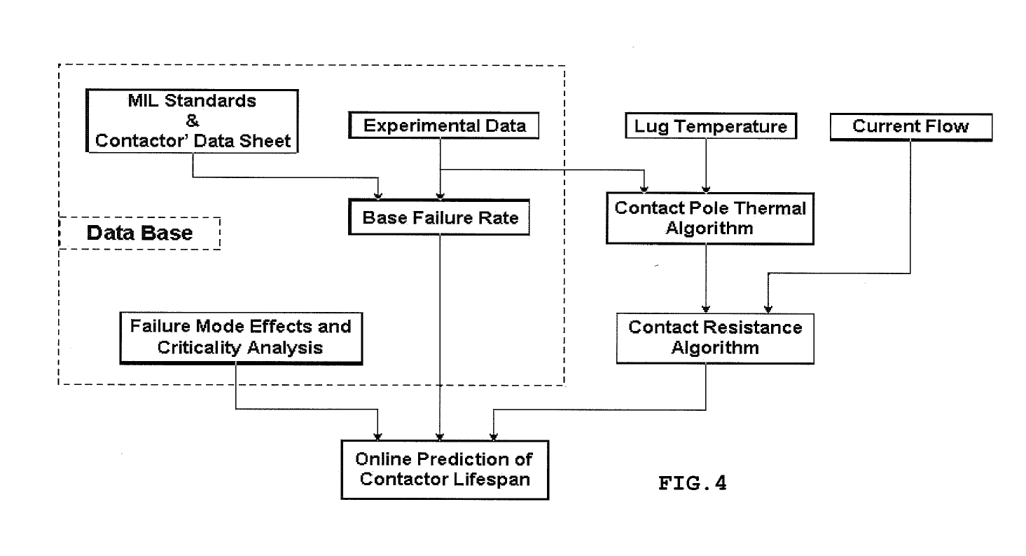

FIG. 4 shows an embodiment with a block diagram structure. A database contains the data sheet relating to technical information from manufacturers or contractors and additionally it stores the data corresponding to predetermined standards. This database also accumulates all the given or effected experimental and empirical results. This information is used to obtain a base failure rate, normally to calculate lifetime or life span. From the measured variables, namely the current flow and the lug temperature, the algorithms described above allow the determination of the switch contact or contact pole temperature and its contact resistance. This last parameter allows the online prediction of contactor lifetime and other maintenance parameters.

What is claimed is:

1. Method for predictive maintenance of switch contactors, the method comprising:
measuring the temperature of an element located outside a switch contactor enclosure, said element being in contact with at least one switch contactor inside said switch contactor enclosure,
calculating said switch contactor temperature based on said element temperature and predetermined correction values,
measuring the current through the switch contactor,
calculating a switch contact resistance value based on said calculated switch contact temperature and said measured current through the contactor,
determining a maintenance parameter of said switch contact based on said calculated switch contact resistance value and predetermined nominal contact resistance values.

2. The method for predictive maintenance of switch contactors according to claim 1, wherein
the element outside the switch contact enclosure is a lug located on the outside surface of the switch contactor enclosure.

3. The method for predictive maintenance of switch contactor according to claim 1, comprising:
updating said maintenance parameter in real time, and
sending the updated output maintenance parameter to a monitoring unit of a wind turbine generator in real time.

4. The method for predictive maintenance of switch contactors according to claim 1, wherein
said maintenance parameter is the estimated lifetime of said switch contactor.

5. The method for predictive maintenance of switch contactors according to claim 1 wherein,
said maintenance parameter is the failure rate of said switch contactor.

6. The method for predictive maintenance of switch contactors according to claim 5 wherein, said failure rate is based on a nominal failure rate multiplied by one or more factors selected from a group consisting of a load stress factor, a switch contact form factor, a cycling factor, an application and construction factor, a quality factor and an environmental factor.

7. The method for predictive maintenance of switch contactor according to claim 6 wherein,
the load stress factor is based on the quotient between the operating load current and the rated resistive load current.

8. The method for predictive maintenance of switch contactor according to claim 6 wherein,
the switch contact form factor, said factor having a value between 2 and 3.

9. The method for predictive maintenance of switch contactor according to claim 6 wherein,
the switch contact cycling factor being approximately 10 when the number of cycles per hour of the switch contact is more than one cycle per hour, and the cycling factor being approximately 0.1 when the number of cycles per hour of the switch contactor is less than on cycle per hour.

10. The method for predictive maintenance of switch contactor according to claim 6, wherein
the application and construction factor is approximately 12 and the quality factor ranging between 0.1 and 1.5.

11. The method for predictive maintenance of switch contactor according to claim 6, wherein
the environmental factor for wind turbines ranges between 0.1 and 1.5.

12. The method for predictive maintenance of a switch contactor according to claim 1, wherein
measuring the first temperature of the lug includes mounting at least one thermocouple temperature sensor on said lug.

13. The method for predictive maintenance of a switch contactor according to claim 1, wherein
calculating said switch contact resistance is based on the equation:
I²R=kT
where I is the current flow though the contactor, R the resistance of the switch contact, T the temperature thereof and k is a constant, wherein
the constant k is suppressed from the calculation by measuring at least a test current Itest, a test contact resistance Rtest and a test contact temperature Ttest.

14. System for predictive maintenance of switch contactors, the system comprising:
a temperature sensor for measuring the temperature of an element located outside a switch contactor enclosure, said element being in contact with at least one switch contactor inside said switch contactor enclosure,
a first calculating unit for calculating said switch contactor temperature based on said element temperature and a predetermined correction value, (look-up-table)
a current sensor for measuring the current through the switch contactor,
a second calculating unit for calculating a switch contact resistance value based on said calculated switch contact temperature and said measured current through the contactor,
a third calculating unit for determining a maintenance parameter of said switch contact by comparing said calculated switch contact resistance value to a predetermined nominal contact resistance value.

15. A system for predictive maintenance of switch contactors according to claim 14, wherein
said current sensor is a current transformer.

16. A system for predictive maintenance of switch contactors according to claim 14, wherein
said temperature sensor is a thermocouple mounted on a lug on said switch contact enclosure.

17. A system for predictive maintenance of switch contactors According to claim 14, wherein
said current sensor and said temperature sensors are connected to a programmable logic computer.

18. A system for predictive maintenance of switch contactors according to claim 14, wherein
said programmable logic computer has an output for sending updated maintenance parameters to a monitoring system of a wind turbine generator.

19. A wind turbine generator comprising a system for predictive maintenance of switch contactors according to claim 1, wherein
said predictive maintenance system is located in the vicinity of the switch contactors that inject current into a rotor circuit of said wind turbine generator.

20. A wind turbine generator according to claim 19 comprising a doubly fed induction generator.
